(19) United States
(12) Patent Application Publication
(10) Pub. No.: US 2026/0075579 A1
(43) Pub. Date: Mar. 12, 2026

(54) POSITIONING SYSTEM

(71) Applicant: ALPS ALPINE CO., LTD., Tokyo (JP)

(72) Inventors: Keigo WAKANA, Miyagi (JP); Daisuke TAKAI, Tokyo (JP); Taiki IGARASHI, Miyagi (JP); Yusuke TERADO, Miyagi (JP)

(21) Appl. No.: 19/388,337

(22) Filed: Nov. 13, 2025

Related U.S. Application Data
(63) Continuation of application No. PCT/JP2024/008413, filed on Mar. 6, 2024.

(30) Foreign Application Priority Data
May 18, 2023 (JP) 2023-082555

(51) Int. Cl. H04W 64/00; H04W 24/10; H04W 84/06

(52) U.S. Cl. CPC H04W 64/006; H04W 24/10; H04W 84/06

(57) ABSTRACT

A positioning system includes a first calculation unit determining a position of a first communication device, a flying object movable with respect to the first communication device, a second communication device mounted on the flying object and communicable with the first communication device, a distance measurement unit measuring a distance between the first communication device and the flying object based on a propagation time or phase of a signal communicated between the first and second communication devices, an angle calculation unit calculating an elevation angle and an azimuth angle of the flying object with respect to the first communication device, and a second calculation unit calculating a position of the flying object based on the position determined by the first calculation unit, the distance measured by the distance measurement unit, and the elevation angle calculated by the angle calculation unit.

### CROSS-REFERENCE TO RELATED APPLICATIONS

This application is a continuation application of International Application No. PCT/JP2024/008413 filed on Mar. 6, 2024 and designated the U.S., which is based upon and claims priority to Japanese Patent Application No. 2023-082555, filed on May 18, 2023, the entire contents of which are incorporated herein by reference.

### BACKGROUND OF THE INVENTION

### 1. Field of the Invention

The present disclosure relates to positioning systems.

### 2. Description of the Related Art

In the related art, there is a positioning system for measuring a position of a flying object by deriving the position of the flying object in a horizontal direction according to a transmission state or a reception state of radio waves at three base stations disposed at three different locations. The positioning system derives the position of the flying object in a vertical direction with respect to the derived position in the horizontal position according to the transmission state or the reception state of laser light at a laser light base station. The locations of the three base stations and the location of the laser beam base station are determined by a global positioning system (GPS) or by a surveying technique (refer to International Publication Pamphlet No. WO 2019/150581, for example).

In the positioning system described above, it is necessary to determine the locations of four places by the GPS or the surveying technique, to obtain the position of the flying object, and an altitude of the flying object is obtained by transmitting the laser light from the laser light base station to the flying object. For this reason, it is difficult to easily obtain the position of the flying object. In addition, the three base stations and the laser beam base station are used to obtain the position of the flying object, thereby making a configuration of the positioning system complex.

### SUMMARY OF THE INVENTION

Accordingly, one object of the present disclosure is to provide a positioning system capable of easily determining a position of a flying object using a simple configuration.

A positioning system according to an embodiment of the present disclosure includes a first communication device including a plurality of antenna elements; a flying object movable with respect to the first communication device, and including a second communication device communicable with the first communication device and an altitude measurement device configured to measure an altitude of the flying object with respect to the first communication device; a memory that stores a program; and a processor configured to execute the program and perform a process including determining a position of the first communication device; measuring a distance between the first communication device and the flying object based on propagation times or phases of signals communicated between the first communication device and the second communication device; calculating an elevation angle of the flying object with respect to the first communication device based on the phases of the signals communicated between the first communication device and the second communication device when the signals are received by the plurality of antenna elements of the first communication device or the second communication device; calculating an azimuth angle of the flying object with respect to the first communication device based on the phases of the signals communicated between the first communication device and the second communication device when the signals are received by the plurality of antenna elements of the first communication device or the second communication device; calculating a position of the flying object based on the position determined by the determining, the distance measured by the measuring the distance, and a first elevation angle calculated by the calculating the elevation angle; and calculating, as a correction value, a difference between the altitude acquired by the altitude measurement device and the distance measured by the measuring the distance in a case where an absolute value of the first elevation angle is less than or equal to a first predetermined angle, and in a case where an absolute value of the first elevation angle is greater than or equal to a second predetermined angle greater than the first predetermined angle after the correction value is calculated by the calculating the correction value, the calculating the elevation angle calculates, as the second elevation angle, an inverse cosine of a value obtained by dividing a value obtained by correcting the altitude acquired by the altitude measurement device using the correction value by the distance measured by the measuring the distance, and selects the first elevation angle or the second elevation angle based on the value of the first elevation angle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of a positioning system according to an embodiment;

FIG. 2 is a diagram illustrating an elevation angle error of a flying object with respect to an antenna array calculated by an angle calculation unit using an AoA method;

FIG. 3A is a diagram for explaining a method for obtaining a correction value;

FIG. 3B is a diagram for explaining a method for correcting an altitude using the correction value;

FIG. 4A is a flow chart illustrating an example of a process performed by a control device of the positioning system according to the embodiment;

FIG. 4B is a flow chart illustrating the example of the process performed by the control device of the positioning system according to the embodiment;

FIG. 5A is a diagram illustrating an example of an xy coordinate system of an array antenna of the positioning system according to the embodiment;

FIG. 5B is a diagram illustrating the xy coordinate system superimposed on an east-north-up coordinate system of the array antenna of the positioning system according to the embodiment;

FIG. 6A is a diagram illustrating an example of a position of an array antennas (anchor) of the positioning system according to the embodiment;

FIG. 6B is a diagram illustrating the earth in a cross section on a plane including the north pole N, the south pole S, and the anchor;

FIG. 7A is a diagram illustrating an example of a position of a flying object (tag) on the earth;

FIG. 7B is a diagram illustrating examples of positions of the tag and the anchor in a case where the earth is viewed from the north pole; and

FIG. 8 is a sequence diagram illustrating an example of process performed by a second position calculation unit of the positioning system.

### DESCRIPTION OF THE PREFERRED EMBODIMENTS

Hereinafter, embodiments applied with a positioning system according to the present disclosure will be described.

### Embodiments

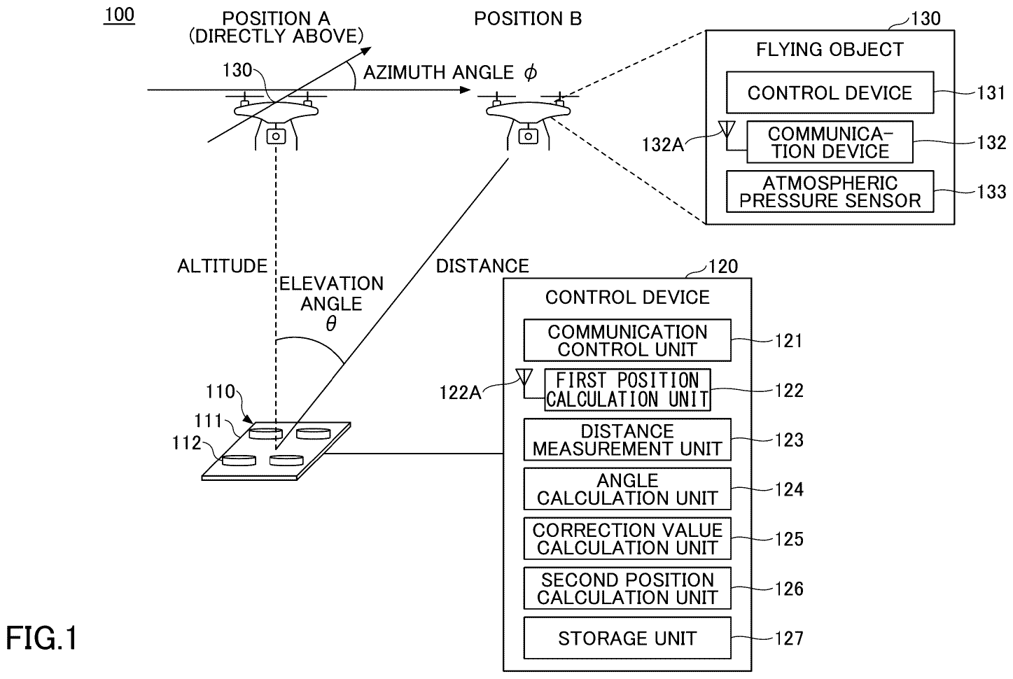

FIG. 1 is a diagram illustrating an example of a configuration of a positioning system 100. The positioning system 100 includes an array antenna 110, a control device 120, and a flying object 130. The array antenna 110 is an example of a first communication device.

The control device 120 of the positioning system 100 measures (or estimates) an elevation angle θ and an azimuth angle φ of the flying object 130 with respect to the array antenna 110 by an angle of arrival (AoA) method. The elevation angle θ is an angle corresponding to a polar angle (zenith angle) in polar coordinates. The control device 120 measures (or estimates) a distance between the array antenna 110 and the flying object 130 by a time of arrival (ToA) method. The elevation angle θ and the azimuth angle φ are an elevation angle and an azimuth angle given in a polar coordinate system using a center of a surface of the array antenna 110 as an origin O.

### <Array Antenna 110>

The array antenna 110 includes a substrate 111 and four antenna elements 112. The substrate 111 is made of an insulating material, and the four antenna elements 112 are provided on an upper surface of the substrate 111. The array antenna 110 is installed on the ground or on a fixed object provided on the ground, for example, and is electrically connected to the control device 120 via wiring.

The four antenna elements 112 are arranged at equal intervals on the upper surface of the substrate 111. More specifically, the four antenna elements 112 are arranged so that a center of each antenna element 112 in a plan view is located at a vertex of a square in the plan view. Although the antenna elements 112 having a circular shape in the plan view is illustrated in FIG. 1, the antenna elements 112 may have a rectangular shape in the plan view.

### <Control Device 120>

The control device 120 is electrically connected to the array antenna 110. The control device 120 may be implemented by a computer including a processor such as a central processing unit (CPU), a random access memory (RAM), a read only memory (ROM), an input/output interface, an internal bus, or the like.

The control device 120 includes a communication control unit 121, a first position calculation unit 122, a distance measurement unit 123, an angle calculation unit 124, a correction value calculation unit 125, a second position calculation unit 126, and a storage unit 127. The communication control unit 121, the first position calculation unit 122, the distance measurement unit 123, the angle calculation unit 124, the correction value calculation unit 125, and the second position calculation unit 126 are illustrated as functional blocks of functions of one or more programs executed by the control device 120. In addition, the storage unit 127 functionally represents the memory of the control device 120.

The communication control unit 121 performs a process for communicating with a communication device 132 of the flying object 130 via the array antenna 110. The communication control unit The communication control unit 121 selects one or more antenna elements 112 to be used for the communication from among the four antenna elements 112 of the array antenna 110. The communication is performed by Bluetooth Low Energy (BLE) (registered trademark), a wireless local area network (WLAN), or the like, for example. Hereinafter, a case where the control device 120 and the communication device 132 of the flying object 130 communicate by the BLE will be described as an example. The communication includes data communication including communication of data such as a phase when a BLE signal is received, in addition to communication for distance measurement and angle measurement.

The first position calculation unit 122 determines a position of the array antenna 110. Determining the position of the array antenna 110 refers to measuring the position of the array antenna 110. The first position calculation unit 122 includes an antenna 122A capable of receiving GPS signals from GPS satellites, for example, and determines the position of the array antenna 110 based on the GPS signals. The first position calculation unit 122 is a global navigation satellite system (GNSS). The position of the array antenna 110 is represented by a latitude and a longitude. For example, a GPS receiver can be used as the first position calculation unit 122. The first position calculation unit 122 may use a system other than the GPS (for example, Galileo in Europe, Michibiki in Japan, or the like) in place of the GPS.

The distance measurement unit 123 measures a distance between the array antenna 110 and the flying object 130, based on a propagation time or a phase of a signal communicated between the array antenna 110 and the communication device 132 of the flying object 130. More specifically, the distance measurement unit 123 measures the distance using the ToA method by utilizing one of the four antenna elements 112 of the array antenna 110.

For example, the distance measurement unit 123 transmits signals at a plurality of frequencies f1 through fN (N is an integer greater than or equal to 2) from the antenna elements 112 to the communication device 132 of the flying object 130, and receives signals at the plurality of frequencies f1 through fN from the communication device 132 of the flying object 130 by the antenna elements 112. The distance measurement unit 123 acquires data representing the phase when the communication device 132 of the flying object 130 receives the signals at each frequency from the communication device 132 of the flying object 130 through communication.

The distance measurement unit 123 acquires a total phase (or a round-trip phase) for each frequency by summing the phase when the antenna elements 112 receive each frequency signal from the communication device 132 and the phase when the communication device 132 of the flying object 130 receives each frequency signal. The distance measurement unit 123 measures the distance between the array antenna 110 and the flying object 130 from a relationship between the plurality of frequencies and the round-trip phase at each frequency.

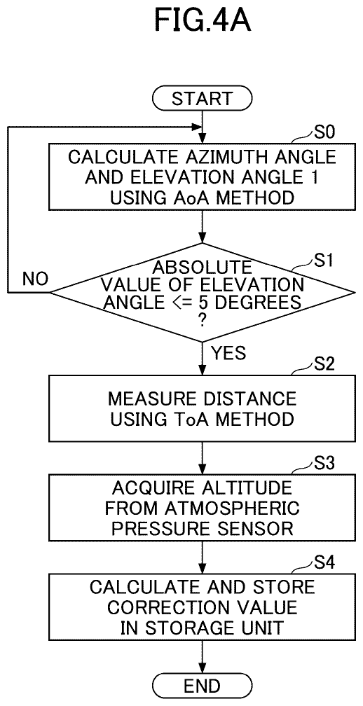

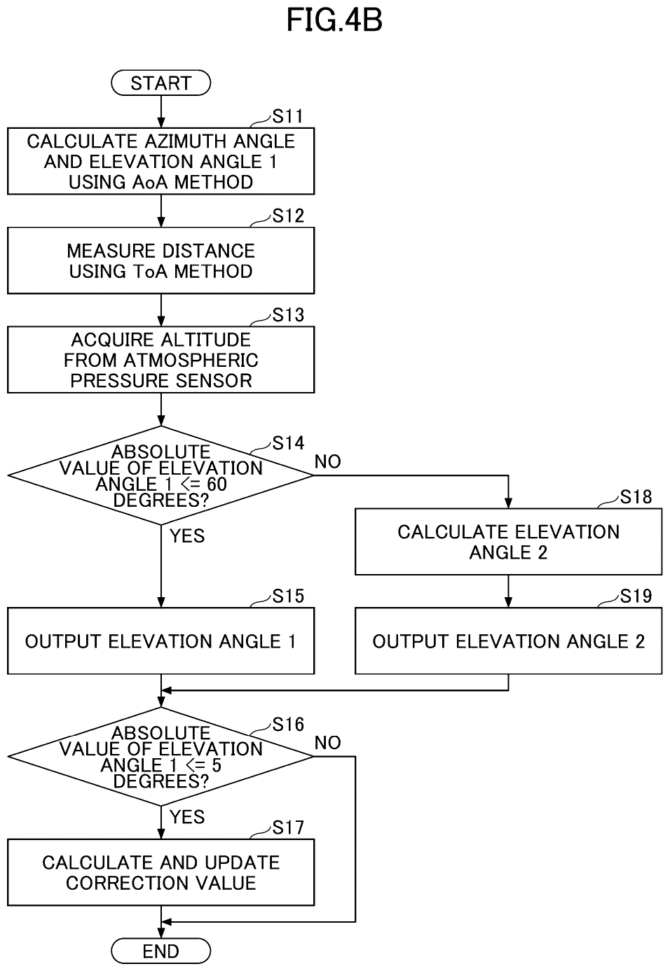

In place of the distance measurement method described above, the distance measurement unit 123 may measure a signal propagation time when the signals are transmitted from the antenna elements 112 to the communication device 132 of the flying object 130 or a signal propagation time when the signals are transmitted from the communication device 132 of the flying object 130 to the antenna elements 112. The distance measurement unit 123 may measure the distance between the array antenna 110 and the flying object 130 by multiplying the speed of light to the measured propagation time. Details of the process performed by the distance measurement unit 123 will be described later with reference to flow charts of FIG. 4A and FIG. 4B.

The angle calculation unit 124 measures the elevation angle θ and the azimuth angle φ of the position of the flying object 130 in the polar coordinate system with respect to the array antenna 110 using the AoA method, by utilizing two or more antenna elements 112 among the four antenna elements 112 of the array antenna 110. The angle calculation unit 124 measures the elevation angle θ and the azimuth angle φ using the AoA method or the ToA method, based on a phase difference when the BLE signal transmitted from the communication device 132 of the flying object 130 is received by two or more antenna elements 112.

Hereinafter, the elevation angle θ calculated by the angle calculation unit 124 using the AoA method is also referred to as an elevation angle 1, and the elevation angle θ calculated by the method using the ToA method is also referred to as an elevation angle 2. The elevation angle 1 is an example of a first elevation angle, and the elevation angle 2 is an example of a second elevation angle. Details of the process performed by the angle calculation unit 124 will be described later with reference to the flow charts of FIG. 4A and FIG. 4B.

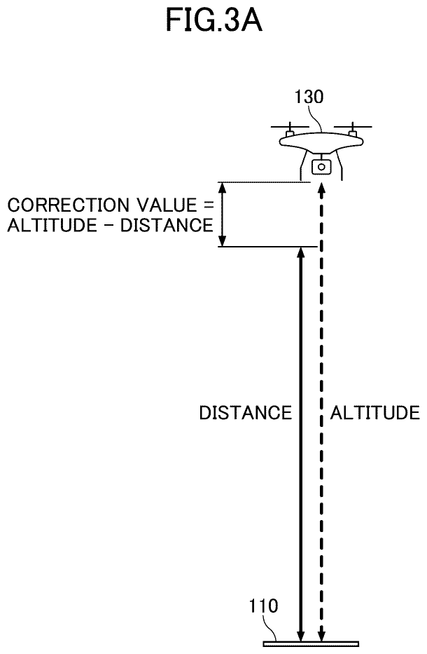

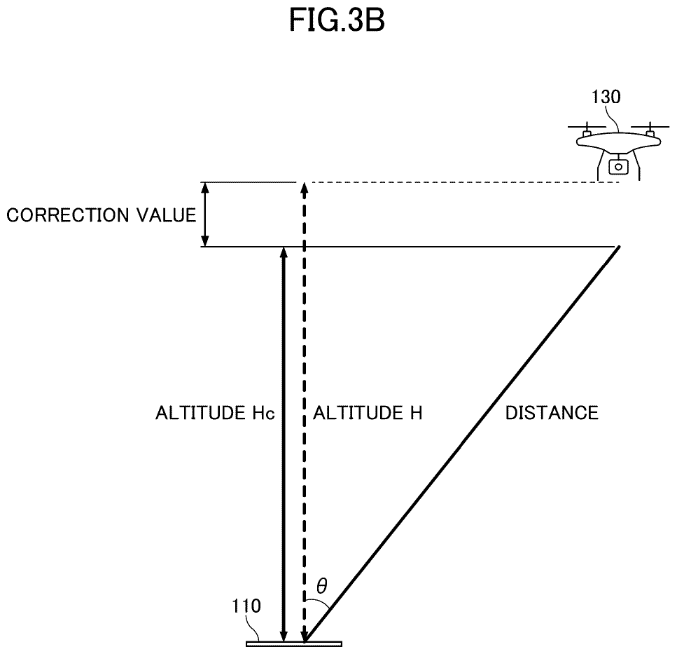

In a case where an absolute value of the elevation angle 1 calculated by the angle calculation unit 124 is less than or equal to a first predetermined angle, the correction value calculation unit 125 calculates a difference between an altitude acquired by an atmospheric pressure sensor 133 and the distance measured by the distance measurement unit 123 as a correction value. The correction value will be described later with reference to FIG. 3A and FIG. 3B.

In a case where the angle calculation unit 124 calculates the elevation angle 1 using the AoA method, the second position calculation unit 126 calculates the position of the flying object 130 based on the position measured by the first position calculation unit 122, the distance measured by the distance measurement unit 123, and the elevation angle 1 calculated by the angle calculation unit 124. The position determined by the first position calculation unit 122 is the latitude and the longitude of the array antenna 110. The distance measured by the distance measurement unit 123 is the distance from the array antenna 110 to the flying object 130. The elevation angle 1 calculated by the angle calculation unit 124 is the elevation angle θ of the flying object 130 with respect to the array antenna 110.

In a case where the angle calculation unit 124 calculates the elevation angle 2 using the ToA method, the second position calculation unit 126 calculates the position of the flying object 130 based on the position determined by the first position calculation unit 122, the distance measured by the distance measurement unit 123, and the elevation angle 2 calculated by the angle calculation unit 124. The elevation angle 2 calculated by the angle calculation unit 124 is the elevation angle θ of the flying object 130 with respect to the array antenna 110.

The storage unit 127 stores one or more programs executed by the control device 120 to perform processes, data required for the processes, or the like.

### <Flying Object 130>

The flying object 130 is a drone, for example, and may be an unmanned aerial vehicle (UAV). The flying object 130 includes a control device 131, the communication device 132, and the atmospheric pressure sensor 133.

The flying object 130 flies according to a control signal transmitted from a remote controller (not illustrated). A camera is mounted on the flying object 130, for example. As an example, the flying object 130 operates the camera based on an imaging signal transmitted from the remote controller, and captures still images (photographs) or moving images (videos).

The control device 131 is implemented by a computer including a processor such as a CPU, a RAM, a ROM, an input/output interface, an internal bus, or the like. Although an illustration of a receiver that receives the control signal from the remote controller is omitted in the flying object 130 illustrated in FIG. 1, the control device 131 performs a flight control or the like of the flying object 130 according to the control signal received from the remote controller.

The communication device 132 includes antenna elements 132A and communicates with the array antenna 110 by BLE. The communication device 132 is an example of a second communication device. The communication includes data communication in addition to communication for distance measurement and angle measurement.

The atmospheric pressure sensor 133 is a sensor that converts the atmospheric pressure into the altitude and outputs the altitude, and measures the altitude of the flying object 130 with respect to the array antenna 110. The atmospheric pressure sensor 133 is an example of an altitude measurement device. The data representing the altitude is transmitted to the array antenna 110 by the control device 131 via the communication device 132, and is input to the control device 120.

Although the atmospheric pressure sensor 133 converts the atmospheric pressure into the altitude and outputs the altitude in this example, the atmospheric pressure sensor 133 may output data representing the atmospheric pressure. In this case, the control device 120 may perform a process for converting the atmospheric pressure into the altitude. Although the atmospheric pressure sensor 133 is used to measure the altitude of the flying object 130 in this embodiment, a device other than the atmospheric pressure sensor 133 that can measure the altitude of the flying object 130 may be used.

### <Error of Elevation Angle Obtained by Angle Measurement>

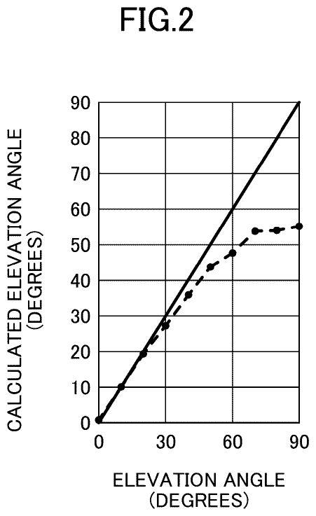

FIG. 2 is a diagram illustrating an error of the elevation angle of the flying object 130 with respect to the array antenna 110 calculated by the angle calculation unit 124 using the AoA method. In FIG. 2, the abscissa indicates an actual elevation angle, and the ordinate indicates the calculated elevation angle. A solid line indicates a relationship between a theoretical value of the elevation angle calculated by the angle calculation unit 124 using the AoA method and the actual elevation angle. A broken line indicates a relationship between the elevation angle actually calculated by the angle calculation unit 124 using the AoA method and the actual elevation angle. The theoretical value of the elevation angle calculated by the angle calculation unit 124 using the AoA method is an elevation angle that is calculated in a case where there are no differences in the arrangements of the four antenna elements 112 on the substrate 111, there are no differences in environments of the four antenna elements 112, and the four antenna elements 112 have identical phase characteristics.

Because the phase characteristics of the four antenna elements 112 of the actual array antenna 110 differ due to the differences in the arrangements of the four antenna elements 112 on the substrate 111, the environments of the four antenna elements 112 such as a positional relationship with a surrounding object having a ground potential, or the like, when the absolute value of the calculated elevation angle θ is approximately 60 degrees or greater as illustrated in FIG. 2, a difference from the theoretical value becomes large to a non-negligible extent.

In the positioning system 100 of this embodiment, because the error becomes large when the absolute value of the elevation angle θ calculated using the AoA method is approximately 60 degrees or greater, the angle calculation unit 124 calculates the elevation angle θ using the ToA method in place of the AoA method. A difference between the azimuth angle φ of the flying object 130 calculated by the angle calculation unit 124 using the AoA method and the theoretical value is within a tolerable range. For this reason, the azimuth angle calculated by the angle calculation unit 124 using the AoA method is used as the azimuth angle φ of the flying object 130.

### <Altitude Correction Method Using Correction Value>

FIG. 3A is a diagram for explaining a method for obtaining the correction value. FIG. 3B is a diagram for explaining a method for correcting the altitude using the correction value.

In FIG. 3A, the altitude detected by the atmospheric pressure sensor 133 mounted on the flying object 130 is indicated by a broken line, and the distance measured by the distance measurement unit 123 using the ToA method in a case where the flying object 130 is located directly above the array antenna 110 is indicated by a solid line. In the case where the flying object 130 is located directly above the array antenna 110, the distance measured by the distance measurement unit 123 using the ToA method corresponds to the altitude of the flying object 130.

Because the altitude detected by the atmospheric pressure sensor 133 is measured with a higher accuracy than the distance measured by the distance measurement unit 123 using the ToA method, there is a difference between the altitude detected by the atmospheric pressure sensor 133 and the distance measured by the distance measurement unit 123 using the ToA method.

In this example, a value obtained by subtracting the distance measured by the distance measurement unit 123 using the ToA method from the altitude detected by the atmospheric pressure sensor 133 is used as the correction value. The process for obtaining the correction value is performed by the correction value calculation unit 125. When calculating the elevation angle θ by the angle calculation unit 124 using the ToA method, the correction value is used to correct the altitude detected by the atmospheric pressure sensor 133 to a value for ToA.

As illustrated in FIG. 3B, in a case where the elevation angle θ of the flying object 130 is large and greater than or equal to a second predetermined angle, the elevation angle θ is obtained from an inverse cosine (acos) of a value obtained by dividing an altitude Hc, which is obtained by subtracting the correction value from the altitude H detected by the atmospheric pressure sensor 133 mounted on the flying object 130, by the distance measured by the distance measurement unit 123 using the ToA method. This process is performed by the angle calculation unit 124, and is a method in which the angle calculation unit 124 calculates the elevation angle 2 using the ToA method. The altitude Hc is calculated from the altitude H and a correction value Cv, from Hc=H−Cv.

The elevation angle 2 can be obtained from the following formula (1), where D denotes the distance measured by the distance measurement unit 123 using the ToA method. Because the accuracy of the atmospheric pressure sensor 133 is approximately several cm, whereas the accuracy of the ToA is approximately several tens of cm and different from the accuracy of the atmospheric pressure sensor 133, the elevation angle 2 is corrected by the value of the atmospheric pressure sensor 133.

$$Elevation angle 2 = acos \{ ( H - Cv ) / D \} \qquad ( 1 )$$

### <Flow Chart>

FIG. 4A and FIG. 4B are flow charts illustrating examples of processes performed by the control device 120.

FIG. 4A illustrates the process performed immediately after a power of the flying object 130 is turned on. As a precondition for the process illustrated in FIG. 4A, when the power is turned on, the flying object 130 flies in a mode in which the absolute value of the elevation angle is controlled to be 5 degrees or less. The flying object 130 flies while communicating with the control device 120 so that the absolute value of the elevation angle calculated by the angle calculation unit 124 is 5 degrees or less.

If the absolute value of the elevation angle of the flying object 130 is 5 degrees or less, the flying object 130 may be regarded as being located directly above the array antenna 110. Because the correction value is calculated in a state where the flying object 130 is located directly above the array antenna 110, the flying object 130 flies so that the absolute value of the elevation angle is 5 degrees or less immediately after the power is turned on. The angle of 5 degrees is an example of the first predetermined angle, and is an angle at which the elevation angle of the flying object 130 located directly above the array antenna 110 falls within a predetermined narrow angle range. The predetermined narrow angle range is a range in which the flying object 130 may be regarded as being located substantially and directly above the array antenna 110. Although the first predetermined angle is 5 degrees in this example, the first predetermined angle is not limited to 5 degrees. The first predetermined angle may be set to an appropriate angle at which the flying object 130 may be regarded as being located substantially and directly above the array antenna 110, according to an accuracy required when utilizing the positioning system 100, a flight range of the flying object 130, or the like.

### <Process Illustrated in FIG. 4A>

When the process starts, the angle calculation unit 124 calculates the azimuth angle φ and the elevation angle 1 using the AoA method (step S0).

The angle calculation unit 124 determines whether the absolute value of the elevation angle of the flying object 130 is less than or equal to 5 degrees (step S1).

When the angle calculation unit 124 determines that the absolute value of the elevation angle θ of the flying object 130 is not less than or equal to 5 degrees (S1: NO), the angle calculation unit returns the process to step S0. When the angle calculation unit 124 determines that the absolute value of the elevation angle θ of the flying object 130 is less than or equal to 5 degrees (S1: YES), the process proceeds to step S2.

Next, the distance measurement unit 123 measures the distance using the ToA method (step S2).

Next, the angle calculation unit 124 acquires the altitude detected by the atmospheric pressure sensor 133 from the flying object 130 (step S3). As a result, the azimuth angle, the elevation angle 1, and the altitude of the flying object 130 are acquired.

The correction value calculation unit 125 calculates the correction value using the distance measured in step S2 and the altitude acquired in step S3, and stores the correction value in the storage unit 127 (step S4). The correction value is calculated by subtracting the distance from the altitude.

Thus, the process illustrated in FIG. 4A ends (END). When the process illustrated in FIG. 4A ends, the control device 120 starts the process illustrated in FIG. 4B.

### <Process Illustrated in FIG. 4B>

When the process illustrated in FIG. 4B starts, the angle calculation unit 124 calculates the azimuth angle and the elevation angle 1 using the AoA method (step S11). When the process illustrated in FIG. 4B starts, the mode in which the absolute value of the elevation angle is controlled to be 5 degrees or less is canceled, and the flying object 130 can freely fly according to the control signal from the remote controller.

Next, the distance measurement unit 123 measures the distance using the ToA method (step S12).

Next, the angle calculation unit 124 acquires the altitude detected by the atmospheric pressure sensor 133 from the flying object 130 (step S13).

The angle calculation unit 124 determines whether or not the absolute value of the elevation angle 1 calculated in step S11 is less than 60 degrees (step S14). As illustrated in FIG. 2, 60 degrees is an angle of a boundary at which the difference between the elevation angle calculated by the angle calculation unit 124 and the theoretical value becomes large to a non-negligible extent, and is an example of the second predetermined angle. The angle of 60 degrees as an example of the second predetermined angle is larger than the angle of 5 degrees as an example of the first predetermined angle. The second predetermined angle of 60 degrees is merely an example, and the second predetermined angle is not limited to 60 degrees. The second predetermined angle may be set to an angle at which it may be regarded that the elevation angle 2 is preferably used in place of the elevation angle 1, according to the accuracy required when utilizing the positioning system 100, the flight range of the flying object 130, or the like.

When the angle calculation unit 124 determines that the absolute value of the elevation angle 1 calculated in step S11 is less than 60 degrees (S14: YES), the angle calculation unit 124 outputs the elevation angle 1 as a current elevation angle of the flying object 130 (step S15). The angle calculation unit 124 measures the elevation angle using the AoA method, based on a phase difference when the BLE signal transmitted from the communication device 132 of the flying object 130 is received by two or more antenna elements 112. That is, the angle calculation unit 124 calculates the elevation angle 1 of the flying object 130 with respect to the array antenna 110 based on the phases of the signals communicated between the array antenna 110 and the communication device 132 when the signals are received by the plurality of antenna elements 112 of the array antenna 110 or the communication device 132.

Next, the angle calculation unit 124 determines whether or not the absolute value of the elevation angle 1 of the flying object 130 is less than or equal to 5 degrees (step S16).

When the angle calculation unit 124 determines that the absolute value of the elevation angle 1 of the flying object 130 is less than or equal to 5 degrees (S16: YES), the correction value calculation unit 125 calculates correction value using the distance measured in step S12 and the altitude acquired in step S13, and updates the correction value stored in the storage unit 127 (step S17). As a result, the correction value is updated to the latest correction value. The correction value is calculated by subtracting the distance from the altitude.

In addition, when the angle calculation unit 124 determines that the elevation angle 1 calculated in step S14 is not less than 60 degrees in step S11 (S14: NO), the angle calculation unit 124 calculates the elevation angle 2 according to the formula (1) using the distance measured in step S12, the altitude acquired in step S13, and the correction value stored in the storage unit 127 (step S18). That is, when the elevation angle 1 is greater than or equal to 60 degrees, the angle calculation unit 124 calculates the elevation angle 2 obtained from an inverse cosine (acos) of a value obtained by dividing a value, which is obtained by correcting the altitude detected by the atmospheric pressure sensor 133 by the correction value, by the distance measured by the distance measurement unit 123.

The angle calculation unit 124 outputs the elevation angle 2 calculated in step S15 as the current elevation angle of the flying object 130 in place of the elevation angle 1 calculated in step S11 (step S19). When the angle calculation unit 124 ends the process of step S19, the angle calculation unit 124 advances the process to step S16.

As described above, because the azimuth angle, the distance, and the elevation angle 1 or 2 can be acquired, the positioning is completed, and a series of steps of the process ends (END). The control device 120 may repeatedly perform the process illustrated in FIG. 4B.

### <Method for Obtaining Position of Flying Object 130>

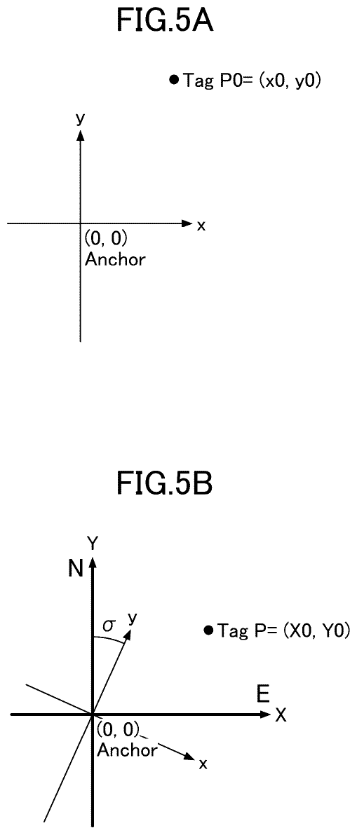

FIG. 5A is a diagram illustrating an example of an xy coordinate system of the array antenna 110. FIG. 5B is a diagram illustrating the xy coordinate system superimposed on an east-north-up (ENU) coordinate system of the array antenna 110 of the positioning system according to the embodiment. Hereinafter, the array antenna 110 may also be referred to as an anchor, and the flying object 130 may also be referred to as a tag.

As illustrated in FIG. 5A, the xy coordinate system of the array antenna 110 is a two-axis orthogonal coordinate system with the position of the array antenna (anchor) 110 as the origin. An angle formed by a y-axis of the xy coordinate system of the array antenna 110 and the north direction (true north direction) is denoted by σ. The xy coordinate system of the array antenna 110 uses lowercase x and y to indicate axes thereof. The angle σ represents an orientation of the y-axis (y-direction) of the xy coordinate system of the array antenna 110.

As illustrated in FIG. 5B, the ENU coordinate system of the array antenna 110 has the position of the array antenna 110 as the origin, the east direction (true east direction) as an X-direction, and the north direction (true north direction) as a Y-direction. The XY coordinates of the ENU coordinate system are denoted by uppercase X and Y. The angle σ is formed by the y-axis of the xy coordinate system of the array antenna 110 (the y-axis in FIG. 5A) and the Y-axis of the ENU coordinate system (refer to FIG. 5B). As illustrated in FIG. 5B, the angle σ is positive when the y-axis of the xy coordinate system is located on the clockwise side with respect to the Y-axis of the ENU coordinate system.

In this example, it is assumed that coordinates P0 of the flying object (tag) 130 in the xy coordinate system of the array antenna 110 illustrated in FIG. 5A are (x0, y0). The x-coordinate x0 can be obtained from the following formula (2A), where r denotes a distance (or range) between the array antenna 110 and the flying object 130. The y-coordinate y0 can be obtained from the following formula (2B). Further, the z-coordinate z0 of the coordinates P0 of the flying object (tag) 130 can be obtained from the following formula (2C). The elevation angle θ is 0 degrees or greater and 90 degrees or less.

$$x 0 = r \times sin θ \times cos ϕ \qquad ( 2 A )$$

$$y 0 = r \times sin θ \times sin ϕ \qquad ( 2 B )$$

$$z 0 = r \times cos θ \qquad ( 2 C )$$

In order to transform the coordinates P0 (x0, y0) of the xy coordinate system into coordinates P (X0, Y0) of the ENU coordinate system illustrated in FIG. 5B, the following formulas (3A) and (3B) may be used.

$$X 0 = cos σ \times x 0 - sin σ \times y 0 \qquad ( 3 A )$$

$$Y 0 = sin σ \times x 0 + cos σ \times y 0 \qquad ( 3 B )$$

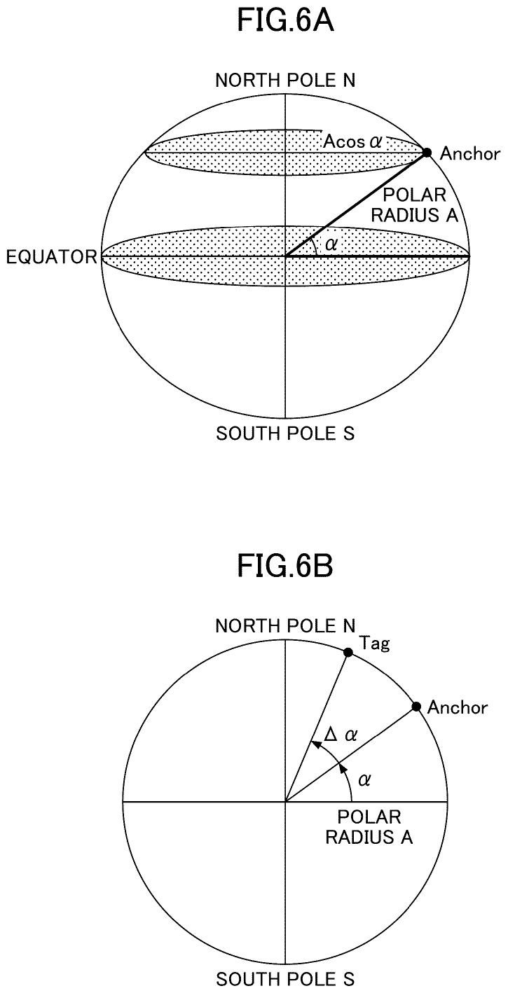

FIG. 6A is a diagram illustrating an example of the position of array antenna (anchor) 110 on the earth. Because the earth is approximated by a sphere in this example, the earth is illustrated as a sphere in FIG. 6A. The radius of the earth is assumed to be a polar radius A (=6356752 m). The radius of the earth may be assumed to be an equatorial radius of (=6378137 m). In addition, the position (latitude, longitude) of the array antenna (anchor) 110 is assumed to be (α, β).

As illustrated in FIG. 6A, in a case where the center of the earth is assumed to be the origin, the elevation angle corresponds to the latitude, and thus, the position of the anchor is represented by the polar radius A as a radius vector, and the elevation angle by α.

FIG. 6B is a diagram illustrating the earth in a cross section on a plane including the north pole N, the south pole S, and the anchor. It is assumed that the tag is located at a position where the latitude is shifted by Δα with respect to the anchor.

The distance between the tag and the anchor is several hundred meters or less, which is a minute distance compared to the radius A of the earth. For this reason, a value ΔY (coordinate difference) obtained by subtracting the Y-coordinate of anchor from the Y-coordinate (Y0) of tag can be approximated by the following formula (4A).

$$Δ Y = A \times Δα \qquad ( 4 A )$$

When the formula (4A) is modified, a latitude difference Δα can be expressed by the following formula (4B).

$$Δα = Δ Y / A \qquad ( 4 B )$$

Because the Y-coordinate of the anchor is 0 in this example, ΔY is the Y-coordinate (Y0)−0 of the tag, and thus, ΔY=Y0.

The latitude of the tag is calculated as α+Δα by adding the latitude difference Δα to the latitude α of the anchor.

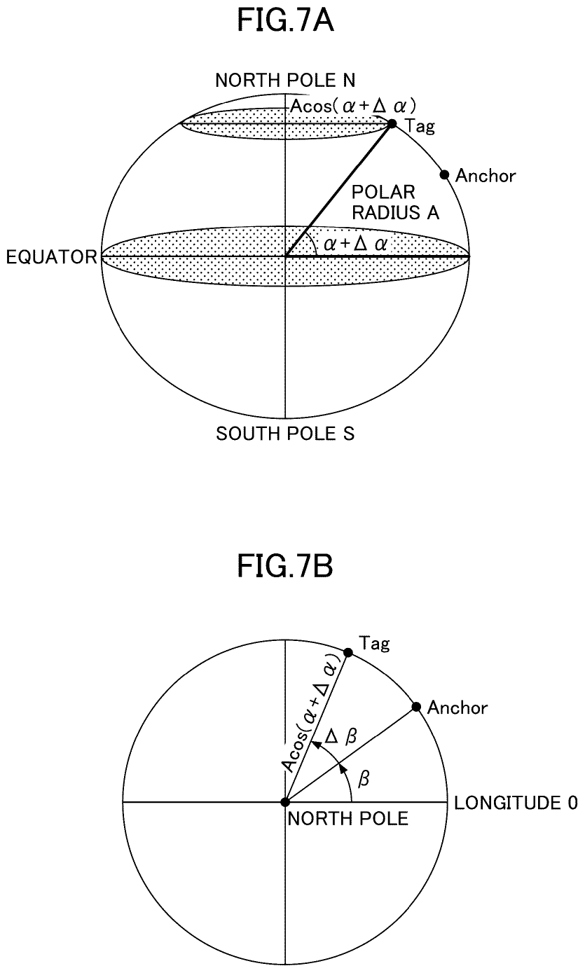

FIG. 7A is a diagram illustrating an example of the position of flying object (tag) 130 on the earth. The earth is illustrated in FIG. 7A, as in FIG. 6A. The position of tag is represented by an elevation angle α+Δα with the polar radius A as the radius vector. A distance from tag to the axis of the earth is represented by Acos (α+Δα).

FIG. 7B is a diagram illustrating examples of the positions of tag and anchor in a case where the earth is viewed from the north pole. FIG. 7B illustrates a cross section of the earth at the latitude of the tag along constant longitudes. The cross section of the earth at the latitude of tag along constant longitudes is represented by a circle having a radius Acos (α+Δα).

Because the distance between the tag and the anchor is several hundred meters or less, which is extremely small compared to the distance Acos (α+Δα) from the tag to the axis of the earth, the anchor is also illustrated in FIG. 7B. Further, it is assumed that the tag is located at a position where the longitude is shifted by Δβ with respect to the anchor.

A value (coordinate difference) ΔX obtained by subtracting the X-coordinate of the anchor from the X-coordinate of the tag can be approximated from the following formula (5A).

$$Δ X = Acos ( α + Δα ) \times Δβ \qquad ( 5 A )$$

When the formula (5A) is modified, the longitude difference Δβ can be expressed by the following formula (5B).

$$Δβ = Δ X / Acos ( α + Δα ) \qquad ( 5 B )$$

Because the X-coordinate of the anchor is 0 in this example, ΔX is the X-coordinate (X0)−0 of the tag, and thus, ΔX=X0.

The longitude of the tag can be calculated as β+Δβ obtained by adding Δβ to the longitude β of the anchor.

Accordingly, the latitude difference Δα and the longitude difference Δβ of the tag with respect to the anchor can be obtained in the manner described above. The latitude α and longitude β representing the position of the anchor are obtained by the first position calculation unit 122 based on the GPS signal. For this reason, the second position calculation unit 126 can calculate a latitude αt and a longitude βt of the tag from the following formulas (6A) and (6B).

$$α t = α + Δα = α + Δ Y / A \qquad ( 6 A )$$

$$β t = β + Δβ = β + Δ X / Acos ( α + Δα ) \qquad ( 6 B )$$

Thus, the second position calculation unit 126 can calculate the position of the flying object 130 in the manner described above.

### <Calculation of Latitude and Longitude of Tag>

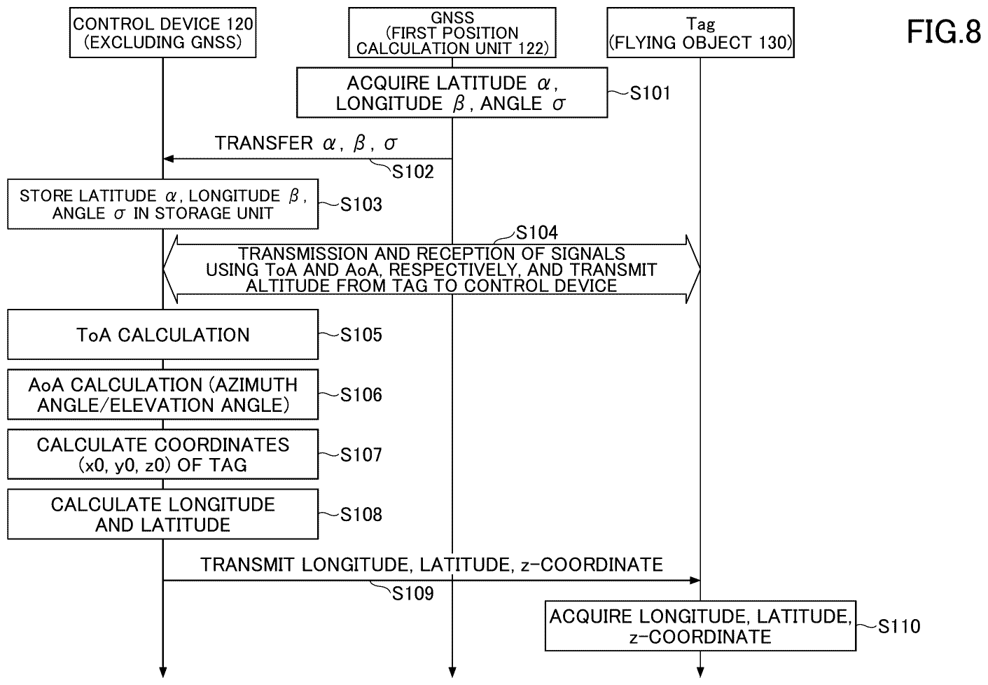

FIG. 8 is a sequence diagram illustrating an example of a process of the entire positioning system 100. FIG. 8 collectively illustrates examples of processes of a portion of the control device 120 excluding the GNSS (first position calculation unit 122), the GNSS (first position calculation unit 122), and the tag (flying object 130).

The GNSS acquires the latitude α, the longitude β, and the angle σ of the anchor (array antenna 110) (step S101). The angle σ may be input by a user of the positioning system 100, for example. The angle σ may be acquired from a geomagnetic sensor, for example.

The GNSS transfers the acquired latitude π, longitude β, and angle σ of the anchor (step S102).

The control device 120 (excluding the GNSS) stores the latitude α, the longitude β, and the angle σ in the storage unit 127 (step S103).

The control device 120 (excluding the GNSS) and the tag (flying object 130) transmit and receive signals to perform the distance measurement and the angle measurement using the ToA method and the AoA method, respectively (step S104). At the control device 120, the distance measurement unit 123 and the angle calculation unit 124 transmit and receive signals to perform the distance measurement and the angle measurement using the ToA method and the AoA method, respectively. In addition, the tag (flying object 130) transmits altitude data indicating the altitude output from the atmospheric pressure sensor 133 to the control device 120.

The distance measurement unit 123 measures the distance r between the array antenna 110 and the flying object 130 using the ToA method, based on the propagation time or phase of the signal communicated between the array antenna 110 and the communication device 132 of the tag (flying object 130) (step S105).

The angle calculation unit 124 measures the elevation angle θ and the azimuth angle φ of the position of the tag (flying object 130) in the polar coordinates with respect to the array antenna 110 using the AoA method (step S106). The angle calculation unit 124 may measure the elevation angle θ and the azimuth angle φ using the ToA method.

The second position calculation unit 126 calculates the coordinates P0 (x0, y0, z0) of the tag (flying object 130) using the distance r, the elevation angle θ, and the azimuth angle φ, based on the formula (2A), the formula (2B), and the formula (2C) (step S107).

The second position calculation unit 126 calculates the latitude and longitude of the tag (flying object 130) (step S108). The second position calculation unit 126 in step S108 transforms the xy coordinates (x0, y0) of the coordinates P0 of the tag into the XY coordinates of the ENU coordinate system according to the formula (3A) and the formula (3B), calculates the latitude difference Δα according to the formula (4B), and calculates the longitude difference Δβ according to the formula (5B). Further, the second position calculation unit 126 calculates the latitude and the longitude of the tag by adding the latitude difference Δα and the longitude difference Δβ to the latitude and the longitude stored in the storage unit 127 in step S103 according to the formula (6A) and the formula (6B).

The second position calculation unit 126 may further perform the process of step S109 to transmit the latitude, the longitude, and the z-coordinate (z0) to the tag (flying object 130).

As a result, in step S110, the tag (flying object 130) acquires the latitude, the longitude, and the z-coordinate (z0).

As described above, the first position calculation unit 122 obtains the position of the anchor (array antenna 110) based on the GPS signal, and adds the latitude difference Δα and the longitude difference Δβ of the tag (flying object 130) with respect to the anchor to the position (latitude and longitude) of the anchor, so that the position (latitude and longitude) of the flying object 130 can be easily calculated. In addition, because the first position calculation unit 122 is sufficient as a GPS receiver that determines the position based on the GPS signal and it is unnecessary to mount a GPS receiver on the flying object 130, the configuration of the positioning system 100 can be simplified. Moreover, because it is unnecessary to mount a GPS receiver on the flying object 130, it is possible to reduce a weight of the flying object 130.

The latitude difference Δα and the longitude difference Δβ of the tag (flying object 130) with respect to the anchor are obtained by the second position calculation unit 126 using the formula (2A), the formula (2B), the formula (3A), the formula (3B), the formula (4B), and the formula (5B) based on the distance r and the elevation angle θ. The distance r is the distance between the array antenna 110 and the flying object 130 calculated by the distance measurement unit 123. The elevation angle θ is the elevation angle of the flying object 130 with respect to the array antenna 110 calculated by the angle calculation unit 124.

The elevation angle θ calculated by the angle calculation unit 124 is the elevation angle 1 or the elevation angle 2 calculated according to the elevation angle of the flying object 130 with respect to the array antenna 110. In addition, the azimuth angle of the flying object 130 is the azimuth angle measured together with the elevation angle by the angle calculation unit 124.

That is, in the case where the angle calculation unit 124 calculates the elevation angle 1 using the AoA method, the second position calculation unit 126 calculates the position of the flying object 130 based on the position determined by the first position calculation unit 122, the distance measured by the distance measurement unit 123, and the elevation angle 1 calculated by the angle calculation unit 124.

Further, in the case where the angle calculation unit 124 calculates the elevation angle 2 using the ToA method, the second position calculation unit 126 calculates the position of the flying object 130 based on the position determined by the first position calculation unit 122, the distance measured by the distance measurement unit 123, and the elevation angle 2 calculated by the angle calculation unit 124.

### <Advantageous Features or Effects>

The positioning system 100 includes: the array antenna 110 (first communication device); the first position calculation unit 122 that determines a position of the array antenna 110; the flying object 130 that is movable with respect to the array antenna 110; the communication device 132 (second communication device) that is mounted on the flying object 130 and communicates with the array antenna 110; the distance measurement unit 123 that measures a distance between the array antenna 110 and the flying object 130 based on the propagation times or the phases of the signals communicated between the array antenna 110 and the communication device 132; the angle calculation unit 124 that calculates an elevation angle of the flying object 130 with respect to the array antenna 110 based on the phases of the signals received by a plurality of antenna elements of the array antenna 110 or the communication device 132 when the signals are communicated between the array antenna 110 and the communication device 132; and the second position calculation unit 126 that calculates the position of the flying object 130 based on the position determined by the first position calculation unit 122, the distance measured by the distance measurement unit 123, and the elevation angle 1 (first elevation angle) calculated by the angle calculation unit 124

Accordingly, it is possible to provide the positioning system 100 capable of easily positioning the flying object using a simple configuration.

The second position calculation unit 126 may calculate the position of the flying object 130 by calculating the coordinate difference (ΔX, ΔY) of the coordinates of the flying object 130 in the ENU coordinate system with respect to the coordinates of the array antenna 110 in the ENU coordinate system based on the distance and the first elevation angle, calculating the difference (Δα, ΔB) of the latitude and the longitude of the flying object 130 with respect to the array antenna 110 based on the coordinate difference, and adding the difference of the latitude and longitude to the latitude and longitude (α, β) representing the position of the array antenna 110. The coordinate difference (ΔX, ΔY) of the coordinates of the flying object 130 in the ENU coordinate system with respect to the array antenna 110 may be transformed into the difference (Δα, Δβ) of the latitude and longitude, and added to the latitude and longitude of the array antenna 110, so that the position of the flying object can be easily determined.

Moreover, in the approximation calculation in which the earth is assumed to be a sphere, the second position calculation unit 126 may calculate the difference Δα in latitude and the difference Δβ in longitude of the flying object 130 with respect to the array antenna 110 using the following formulas (7A) and (7B), where A denotes the radius of the earth that is assumed to be a sphere.

$$Δα = Δ Y / A \qquad ( 7 A )$$

$$Δβ = Δ X / Acos ( α + Δα ) \qquad ( 7 B )$$

In the approximation calculation in which the earth is assumed to be a sphere, the difference Δα in latitude and the difference Δβ in longitude of the flying object 130 with respect to the array antenna 110 can be easily calculated, and the position of the flying object 130 can be easily determined by adding the difference Δα and the difference Δβ to the latitude and the longitude of the array antenna 110.

The angle calculation unit 124 may further calculate the azimuth angle of the flying object 130 with respect to the array antenna 110 based on the phases of the signals received by the plurality of antenna elements of the array antenna 110 or the communication device 132 when the signals are communicated between the array antenna 110 and the communication device 132. The azimuth angle of the flying object 130 can also be acquired.

The array antenna 110 may include the antenna elements 112 arranged in a vertically upward direction. In this case, it is possible to improve radiation characteristics of the array antenna 110, and easily determine the position of the flying object 130.

The flying object 130 may further include the atmospheric pressure sensor 133 (altitude measurement device) that is mounted on the flying object 130 and detects the altitude of the flying object 130 with respect to the array antenna 110, and the correction value calculation unit 125 that calculates, as the correction value, the difference between the altitude acquired by the atmospheric pressure sensor 133 and the distance measured by the distance measurement unit 123. In a case where the absolute value of the elevation angle 1 is greater than or equal to the second predetermined angle greater than the first predetermined angle after the correction value is calculated by the correction value calculation unit 125, the angle calculation unit 124 may calculate, as the elevation angle 2 (second elevation angle), the inverse cosine of the value obtained by dividing the value obtained by correcting the altitude acquired by the atmospheric pressure sensor 133 using the correction value by the distance measured by the distance measurement unit 123, and select the elevation angle 1 or the elevation angle 2 based on the value of the elevation angle 1.

Accordingly, when the elevation angle is large, the elevation angle is calculated from the distance corrected by the value of the atmospheric pressure sensor 133, and thus, it is possible to provide the positioning system 100 capable of reducing the angle measurement error and easily determining the position of the flying object 130 using a simple configuration.

When the angle calculation unit 124 calculates the elevation angle 2, the second position calculation unit 126 may calculate the position of the flying object 130 based on the position determined by the first position calculation unit 122, the distance measured by the distance measurement unit 123, and the elevation angle 2. For this reason, in a case where the absolute value of the elevation angle 1 is greater than or equal to the second predetermined angle (for example, 60 degrees) larger than the first predetermined angle (for example, 5 degrees) and the error of the elevation angle 1 calculated based on the phases of the signals received by the plurality of antenna elements 112 of the array antenna 110 is large, it is possible to provide the positioning system 100 capable of easily determining the position of the flying object 130 using a simple configuration based on the elevation angle 2.

The first predetermined angle (for example, 5 degrees) is an angle at which the elevation angle of the flying object 130 located directly above the array antenna 110 falls within a predetermined narrow angle range. The predetermined narrow angle range is a range in which the flying object 130 may be regarded as being located substantially and directly above the array antenna 110. For this reason, when the flying object 130 is located at the position substantially and directly above the array antenna 110, the correction value can be calculated using the distance measured by the distance measurement unit 123 using the ToA method (the distance corresponding to the altitude of the flying object 130) and the altitude detected by the atmospheric pressure sensor 133.

Moreover, when the absolute value of elevation angle 1 becomes less than or equal to the first predetermined angle (for example, 5 degrees), the correction value calculation unit 125 calculates the difference between the altitude acquired by atmospheric pressure sensor 133 and the distance measured by distance measurement unit 123 as the correction value, and updates the correction value. Thus, when flying object 130 is located at the position substantially and directly above the array antenna 110, the correction value can be updated to the latest correction value.

Further, because the atmospheric pressure sensor 133 measures the altitude of the flying object 130 based on the atmospheric pressure, it is possible to accurately detect the altitude of the flying object 130, and calculate the correction value with a high accuracy. In a case where the error of the elevation angle 1 calculated based on the phases of the signals received by the plurality of antenna elements 112 of the array antenna 110 is large, the elevation angle 2 can be calculated with a high accuracy using the altitude acquired by the atmospheric pressure sensor 133 and the correction value, in place of the elevation angle 1.

The distance measurement unit 123, the angle calculation unit 124, and the correction value calculation unit 125 are provided on the array antenna 110 side, and the array antenna 110 may include three or more antenna elements 112. That is, the control device 120 may include a first control device (or processor) and a second control device (or processor), and the communication control unit 121, the first position calculation unit 122, the second position calculation unit 126, and the storage unit 127 may be implemented by the first control device, while the distance measurement unit 123, the angle calculation unit 124, and the correction value calculation unit 125 may be implemented by the second control device. For this reason, the control device 120 installed on the ground or on a fixed object provided on the ground can stably calculate the distance between the array antenna 110 and the flying object 130 and the correction value, and can stably calculate the elevation angle 1 using the phase difference obtained using the three or more antenna elements 112. In addition, it is possible to stably calculate the elevation angle 2 using the stably calculated distance and correction value.

Because the communication device 132 has one antenna element 132A, under a precondition that the ground-side control device 120 calculates the distance, the correction value, the elevation angle 1, and the elevation angle 2, the communication device 132 of the flying object 130 can be configured to measure the phases of the signals when the signals transmitted from the array antenna 110 are received, and to transmit the signals when the control device 120 measures the elevation angle and the azimuth angle of the flying object 130 using the AoA method, thereby simplifying the configuration on the flying object 130 side.

### <Modification>

In the embodiment described above, the ground-side control device 120 performs the measurement of the distance using the ToA method, the measurement of the elevation angle 1 and the azimuth angle using the AoA method, the calculation of the correction value, and the calculation of the elevation angle 2. However, the control device 131 of the flying object 130 may perform the measurement of the distance using the ToA method, the measurement of the elevation angle 1 and the azimuth angle using the AoA method, the calculation of the correction value, and the calculation of the elevation angle 2. In this case, the communication device 132 of the flying object 130 includes a plurality of antenna elements 132A to detect the phase difference of the signals when measuring the elevation angle 1 and the azimuth angle using the AoA method. Moreover, in this case, at least one antenna element 112 may be provided on the ground-side in place of the array antenna 110. The flying object 130 may transmit the elevation angle 1, the azimuth angle, the correction value, and the elevation angle 2 to the array antenna 110, and the control device 120 may receive the elevation angle 1, the azimuth angle, the correction value, and the elevation angle 2 via the array antenna 110.

According to the present disclosure, it is possible to provide a positioning system capable of easily determining a position of a flying object using a simple configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A positioning system comprising:
a first communication device including a plurality of antenna elements;
a flying object movable with respect to the first communication device, and including a second communication device communicable with the first communication device and an altitude measurement device configured to measure an altitude of the flying object with respect to the first communication device;
a memory that stores a program; and
a processor configured to execute the program and perform a process including:
determining a position of the first communication device;
measuring a distance between the first communication device and the flying object based on propagation times or phases of signals communicated between the first communication device and the second communication device;
calculating an elevation angle of the flying object with respect to the first communication device based on the phases of the signals communicated between the first communication device and the second communication device when the signals are received by the plurality of antenna elements of the first communication device or the second communication device;
calculating an azimuth angle of the flying object with respect to the first communication device based on the phases of the signals communicated between the first communication device and the second communication device when the signals are received by the plurality of antenna elements of the first communication device or the second communication device;
calculating a position of the flying object based on the position determined by the determining, the distance measured by the measuring the distance, and a first elevation angle calculated by the calculating the elevation angle; and
calculating, as a correction value, a difference between the altitude acquired by the altitude measurement device and the distance measured by the measuring the distance in a case where an absolute value of the first elevation angle is less than or equal to a first predetermined angle, and
in a case where an absolute value of the first elevation angle is greater than or equal to a second predetermined angle greater than the first predetermined angle after the correction value is calculated by the calculating the correction value, the calculating the elevation angle calculates, as the second elevation angle, an inverse cosine of a value obtained by dividing a value obtained by correcting the altitude acquired by the altitude measurement device using the correction value by the distance measured by the measuring the distance, and selects the first elevation angle or the second elevation angle based on the value of the first elevation angle.

2. The positioning system as claimed in claim 1, wherein the calculating the position includes:
calculating a coordinate difference (ΔX, ΔY) of coordinates in an east-north-up coordinate system of the flying object with respect to coordinates in an east-north-up coordinate system of the first communication device based on the distance and the first elevation angle, and
calculating a difference (Δα, Δβ) in latitude and longitude of the flying object with respect to the first communication device based on the coordinate difference, and
calculating the position of the flying object by adding a difference between the latitude and the longitude to the latitude and the longitude (α, β) representing the position of the first communication device.

3. The positioning system as claimed in claim 2, wherein the calculating the position calculates a difference Δα in the latitude and a difference Δβ in the longitude of the flying object with respect to the first communication device using formulas (1A) and (1B) in an approximation calculation in which earth is assumed to be a sphere,
$$Δα = Δ Y / A \qquad ( 1 A )$$
$$Δβ = Δ X / Acos ( α + Δα ) \qquad ( 1 B )$$
where A denotes a radius of the earth assumed to be the sphere.

4. The positioning system as claimed in claim 1, wherein the first communication device includes an antenna element arranged in a vertically upward direction.

5. The positioning system as claimed in claim 1, wherein the calculating the position calculates the position of the flying object based on the position determined by the determining the position, the distance measured by the measuring the distance, and the second elevation angle when the calculating the elevation angle calculates the second elevation angle.

6. The positioning system as claimed in claim 1, wherein the calculating the elevation angle calculates the first elevation angle using an angle of arrival method, and calculates the second elevation angle using a time of arrival method.

7. The positioning system as claimed in claim 1, wherein the first predetermined angle is an angle at which an elevation angle directly above the first communication device is within a predetermined narrow angle range.

8. The positioning system as claimed in claim 1, wherein the calculating the correction value calculates a difference between the altitude acquired by the altitude measurement device and the distance measured by the measuring the distance as the correction value, and updates the correction value when the absolute value of the first elevation angle becomes less than or equal to the first predetermined angle.

9. The positioning system as claimed in claim 1, wherein the altitude measurement device includes an atmospheric pressure sensor configured to measure the altitude of the flying object based on atmospheric pressure.

10. The positioning system as claimed in claim 1, wherein:
the processor includes a first processor and a second processor,
the first processor performs a process including the determining the position, and calculating the position,
the second processor performs a process including the measuring the distance, the calculating the elevation angle, the calculating the azimuth angle, and the calculating the correction value, and
the first communication device includes three or more antenna elements.

11. The positioning system as claimed in claim 10, wherein the second communication device includes one antenna element.
